(19) United States
(12) Patent Application Publication
(10) Pub. No.: US 2003/0182241 A1
(43) Pub. Date: Sep. 25, 2003

(54) Time variable financial authentication apparatus

(76) Inventor: Glenn Cobourn Everhart, Smyrna, DE (US)

Correspondence Address: HUNTON & WILLIAMS, 1900 K STREET NW, SUITE 1200, WASHINGTON, DC, 20006-1109, US

(21) Appl. No.: 10/105,471

(22) Filed: Mar. 25, 2002

(51) Int. Cl. G06F 17/60

(52) U.S. Cl. 705/65

(57) ABSTRACT

A system is disclosed which permits tokens used for finance to be checked for authenticity by having the tokens display an authentication code that varies with time, yet can be validated by the token validation authority. Because this code changes, it will not be stored and stolen as existing codes are. This reduces fraud for all involved where there is risk that a token might be a forgery.

### CROSS-REFERENCE TO RELATED APPLICATIONS

Not Applicable

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING

Not Applicable

### BACKGROUND OF THE INVENTION

Since the ancient invention of money, problems of counterfeiting have existed. These have led to ever more sophisticated measures to make the injection of false tokens representing value from succeeding. When in much more recent times credit cards were introduced, such measures were incorporated. Initially, only a check digit formed by a secret algorithm was used to validate card numbers, the number space being very sparsely occupied so that the chance of finding a valid card number was relatively low. Then thieves learned how to forge this digit, so secret cryptography-based codes were added to the cards and checked by the card issuer when charges were made. These have been useful in reducing fraud until recently. However, with the practice of merchants storing card numbers, including some of the codes, insecurely on the Internet, there have been enough thefts of these numbers so that fraud is becoming an increasingly difficult problem, mainly in cases where the cards are not physically present. (Credit cards contain fraud avoidance devices like holograms which make counterfeiting of physical cards more difficult than counterfeiting numbers off the cards.) Rules designed to prohibit storing the secret codes have been ignored, even by large issuers (as reported in news stories) and as a result a new way to prevent fraudulent card use for remote customers is becoming necessary. Smart cards using public key encryption have been introduced, but these have met with little acceptance, due to their need for gadgetry to read them which is not widely available. This invention provides a solution to this problem and related ones, which is easily explained to all concerned and requires only minor infrastructure changes. The preferred implementation will be described with credit cards, though the idea is somewhat broader.

Prior art in the area of time based codes reaches back to ancient times, when the password of the day was common in military camps. The notion of using widely synchronized times to control functions dates at least to the philopophy of Gottfried Liebniz (coinventor of the calculus and a contemporary of Isaac Newton). During World War II, codebooks valid for a particular day were used by both sides. The use of time stamps in computer communication is almost as old as computing, though an example of their use in authentication can be found in the Kerberos system (MIT, 1987). Financial transactions have been timestamped to avoid replay problems also, and this practice is at least 20 years old (going back at least as far as the use of X.25 networks for finance).

### BRIEF SUMMARY OF THE INVENTION

The present invention is that one might supply a display on the consumer device, which displays an authentication code that varies with time, all times being synchronized to a known base time, and such that an authenticating authority (the issuer, generally, for credit cards) can determine whether the correct code is being sent to it for a particular consumer device and for a particular transaction time. The time variability is obscured by a secret process on the consumer device to prevent those not in possession of the secret from figuring out the code sequence, so that the authenticating authority can decide whether the requested transaction comes from a valid source. Because the display number is variable, it cannot be recorded on the Internet or elsewhere in form useful for theft save for very limited durations, and such recorded numbers cannot be used to aid in impersonating a holder of a consumer device (e.g., a credit card) for purposes of identity theft. Widespread use of this invention will make telephone, network, or other remote commerce safer for all involved.

### BRIEF DESCRIPTION OF THE SEVERAL VIEWS OF THE DRAWING

Not Applicable

### DETAILED DESCRIPTION OF THE INVENTION

On a token which is used to indicate authority to perform transactions (such as a credit card), let there be a clock which can maintain synchronization with a reference clock during the lifetime of the token, to within one or a few times the interval between changes of identifier. In the preferred implementation this would be a counter which “ticks” (changes value) one or a few times per day. Let there be on the token also a means of performing a secret transform on this clock value (which transformation preferentially should also involve some other separately observable attribute of the token, such as the credit card number). This process should use a secret not available to the token holder, but reproducible by an authentication authority. Again, preferentially, the secret should be different for every such token so that if one is lost, only its secret is lost and other tokens remain secure. The result of this transform, or part of it, is displayed by the token in such a way that the display can be read by whatever reads the token and transmitted to the authentication authority. Optionally such an authority might demand that additional memorized digits or the like be supplied, so that a stolen token could not easily be used.

The preferred implementation of this would be on a credit card. In addition to the existing credit card fields, magstripe, and so on, the card gets a small processor and battery, and a display somewhere on the card which would show a few digits computed by a secret process on the card. One such implementation might take a secret master key known to the issuer and encrypt the card account number and expiration with this master key. This diversified key then gets stored on the card. (Note the diversified key is different for each card.) Now to compute the display, the clock (actually a counter of some kind, perhaps set for all cards to “hours since midnight on Jan. 1, 2001 ” and synchronized when issued) is encrypted with the diversified key, and the low 3 decimal digits of the result are displayed on the small display. There exist flexible numeric displays much thinner than credit cards. Should power be limited to drive such a display all the time for a few years, a pushbutton or other switch might be present to conserve power. When the credit card holder of this new device makes a phone or net purchase, he then reads the display and possibly recites some other digits he is given to memorize and furnishes that to the merchant who sends it to the issuer for validation. (This is similar to existing practice where merchants ask for the fixed CVV code (card validation value) on the back of the credit card.) The card issuer receives the card number, timestamp of the transaction, and the added data. The issuer then derives the diversified key from the card number and the master secret it holds (or reads it from storage), checks the timestamp supplied for sanity, and uses it to derive the expected on-card clock value. He then encrypts this clock value with the diversified key and compares with the value supplied by the customer. To avoid clock drift problems, he will compare adjacent timeslot values for this operation also and treat these as matches if one of them produces the same code as was reported. The exact number of these comparisons depends on expected maximum clock drift on card over the card lifetime (typically two to three years). For example if it is expected the clock might drift under an hour, and it changes value at midnight, then transactions after 11 PM might be compared also with the next day's code, and similarly transactions before 1 AM might be compared with the prior day's code. In this way the card user never sees any effects of the clock changing during his transaction.

In addition, other values may be supplied to the cardholder (or more generqlly the token holder) which can be recorded by the authentication authority or can be computed by such an operation as encrypting card number with a second secret key and using part of that for check digit(s) to be entered along with the displayed number by the cardholder. Such added information would make the card less useful to someone who stole a card, as they would have to guess the correct check digit(s) to fool the authentication authority. It is good practice for the display values to be related mathematically to some separate observable about the token here. For credit cards, the preferred implementation encrypts the card number. For things like cell phones, there is a phone ID number which could be used. Such practice would make it harder to forge tokens and will be found to be essential for tokens in which the internal state cannot be hidden well from users. In those cases, the other identifiers used must be separately read to gain the added protection against fraud.

Definitions

“Display”, as used above, means whatever sends information off the token for authentication checks. For credit cards, this would be some visible display. For other types of tokens, the display might be a radio or audio signal, or magnetic patterns also. The checking is in all cases to be done off the token, although a central authority might be replaced in some cases by some combination of other processing with perhaps other tokens whose trust is established in other ways (biometrics, perhaps) to allow local checking of such tokens for authenticity.

“Authenticating authority” as used here means either a central authority (as in the preferred implementation) or a distributed one capable of deciding whether to authorize transactions where a token is provided as a way to permit them.

“Authority to perform transactions” in the scope of this invention means designating posessing some means of payment or authority to pay for something, or other financial authority of similar nature.

“Token” means a device which is presented or which bears information which is presented by someone to set up payment or similarly authorize some financial or financial-related transaction. A credit card is a token. A gasoline-buying “fastpass” is also a token. A securid is not a token as the word is used here.

1. What I claim as my invention is a method for authenticating finance or finance related transactions, consisting of
a. a token device which contains a counter which keeps time and is synchronized to a time base,
b. logic capable of transforming this counter's values by means of a process involving a secret known to itself and an authenticating authority into a sequence of numbers such that the transformed values of the counter cannot be predicted without possession of the secret, and
c. a display of all or part of the transformed value, which is
d. reported along with other information from the token (and optionally with additional memorized information from the token holder) which will identify it to the authenticating authority, which
e. uses its counter of time which is already synchronized with the counter on the token and
f. duplicates the transforming logic in the token and
g. compares the part of the transformed value reported (from step d above) with its computation and
h. uses equality of these to verify that the token is legitimate, and
i may use optional additional information memorized by the token holder and sent in step d to validate that the token holder is the authorized one.
